(19) United States
(12) Patent Application Publication
(10) Pub. No.: US 2011/0133145 A1
(43) Pub. Date: Jun. 9, 2011

(54) FENCE COLUMNS, FENCES INCLUDING SUCH FENCE COLUMNS AND RELATED METHODS

(75) Inventor: Brian Morrow, Provo, UT (US)

(73) Assignee: BLUE TOMATO, LLC, Provo, UT (US)

(21) Appl. No.: 12/631,495

(22) Filed: Dec. 4, 2009

(51) Int. Cl. E04H 17/16; E04H 17/20; B23P 11/00

(52) U.S. Cl. 256/24; 256/65.11; 256/65.12; 29/428

(57) ABSTRACT

Fence columns, fences including such columns, and related methods of fence assembly and disassembly are disclosed. A column for a column and panel fence may include an elongated member, column faces, and a cross-piece. The elongated member may have a first end and a second end, and the first end may be secured to a footing. A first column face and an opposing second column face may form at least one channel therebetween sized and configured to receive an end portion of at least one fence panel. The cross-piece may have a first end coupled to the first column face, a second end coupled to the second column face and an intermediate portion coupled to the second end of the elongated member. Additionally, the cross-piece and the elongated member may be held in tension by the footing, the first column face and the second column face.

### BRIEF SUMMARY

In some embodiments, a column for a column and panel fence includes an elongated member, column faces, and a cross-piece. The elongated member may have a first end secured to a footing and a second end. A first column face and an opposing second column face may form at least one channel therebetween sized and configured to receive an end portion of at least one fence panel. The cross-piece may have a first end coupled to the first column face, a second end coupled to the second column face and an intermediate portion coupled to the second end of the elongated member. The cross-piece and the elongated member may be placed in tension by the footing, the first column face and the second column face at least when an end portion of at least one fence panel is positioned in the at least one channel.

In additional embodiments, a column and panel fence includes a plurality of panels positioned substantially end-to-end, and a plurality of columns supporting the plurality of panels. Each column of the plurality of columns may include an elongated member, column faces, and a cross-piece. The elongated member may have a first end secured to a footing and a second end, and be placed between ends of adjacent panels of the plurality A first column face and an opposing second column face may form at least one channel therebetween sized and configured to receive an end portion of at least one fence panel. The cross-piece may have a first end coupled to the first column face, a second end coupled to the second column face and an intermediate portion coupled to the second end of the elongated member. The cross-piece and the elongated member may be placed in tension by the footing, the first column face and the second column face.

In further embodiments, a reusable concrete fence may include a plurality of concrete panels positioned substantially end-to-end; and a plurality of columns supporting the plurality of panels. Each column of the plurality of columns may include a reusable elongated member having a first end releasably coupled to a footing and a second end, a first concrete column face and an opposing second concrete column face forming at least one channel therebetween receiving an end portion of at least one concrete panel of the plurality of concrete panels. Each column of the plurality of columns may further include a reusable cross-piece having a first end coupled to the first column face, a second end coupled to the second column face and an intermediate portion coupled to the second end of the elongated member by a threaded connection, the cross-piece and the elongated member being placed in tension by the footing, the first column face and the second column face.

In additional embodiments, a method of assembling a column and panel fence may include coupling an extending member to a footing, and positioning an end portion of at least one panel proximate the extending member. The method may further include positioning a first column face adjacent the end portion of the at least one panel and a second column face adjacent the end portion of the at least one panel, opposing the first column face. The method may additionally include coupling a cross-piece to the extending member, the first column face and the second column face, placing the cross-piece and extending member into tension with the footing, first column face and second column face, and longitudinally compressing the first column face and the second column face with the cross-piece.

In yet further embodiments, a fence kit may include an elongated member having a first end configured for securing to a footing and a second end, a first column face and an opposing second column face configured for forming at least one channel therebetween sized and configured to receive an end portion of at least one fence panel. The fence kit may further include a cross-piece having a first end sized and configured to couple to the first column face, a second end sized and configured to couple to the second column face and an intermediate portion configured to couple to the second end of the elongated member, the cross-piece and the elongated member sized and configured to be assembled and placed in tension by the footing, the first column face and the second column face at least when an end portion of at least one fence panel is positioned in the at least one channel.

### BRIEF DESCRIPTION OF THE SEVERAL VIEWS OF THE DRAWINGS

FIG. 1 shows a front view of a column and panel fence, according to an embodiment of the present invention.

FIG. 2 shows a cross-sectional front view of a portion including a column of the column and panel fence shown in FIG. 1.

FIG. 3 shows a cross-sectional side view of a precursor assembly for forming a column and panel fence, such as shown in FIG. 1, the precursor assembly including a footing, elongated member and a retaining bracket.

FIG. 4 shows the precursor assembly of FIG. 3 further including a panel positioned on the footing.

FIG. 5 shows the precursor assembly of FIG. 4 further including a first column face positioned against a side of the panel.

FIG. 6 shows the precursor assembly of FIG. 5 further including a second column face positioned against an opposing side of the panel.

FIG. 7 shows the precursor assembly of FIG. 6 further including a cross-piece positioned over the column faces and coupled to the elongated member.

FIG. 8 shows the precursor assembly of FIG. 7 wherein the cross-piece is coupled to the column faces, and wherein the cross-piece and elongated member are put into tension to form a column.

FIG. 9 shows the column of FIG. 8 further including a cap positioned over the column faces and the cross-piece.

FIG. 10 shows a cross-sectional side view of a precursor assembly for forming a column and panel fence, the assembly including a reusable elongated member attached to a footing by a reusable joint.

FIG. 11 shows a cross-sectional side view of a precursor assembly for forming a column and panel fence, the assembly including a reusable footing.

FIG. 12 shows a cross-sectional side view of a precursor assembly for forming a column and panel fence, the assembly including a reusable footing including a reusable subterranean portion.

FIG. 13 shows a top view of a column of a column of the column and panel fence of FIG. 1, without a cap thereon.

FIG. 14 shows an upper portion of the precursor assembly of FIG. 6 further including a cross-piece having relatively rigid end portions and a relatively flexible intermediate portion positioned over the column faces and coupled to the elongated member.

FIG. 15 shows the upper portion of the precursor assembly of FIG. 14 wherein the cross-piece is coupled to the column faces, and wherein the cross-piece and elongated member are put into tension to form a column.

FIG. 16 shows a top view of a column including a cross-piece, such as is shown in FIGS. 14 and 15, wherein the relatively flexible portion comprises a relatively flexible metal sheet.

FIG. 17 shows a top view of a column including a cross-piece, such as is shown in FIGS. 14 and 15, wherein the relatively flexible portion comprises cables.

FIG. 18 shows an upper portion of the precursor assembly of FIG. 6, further including discrete coupling features formed in the column faces and a cross-piece including cables positioned within the discrete coupling features.

FIG. 19 shows the upper portion of the precursor assembly of FIG. 18 wherein the cross-piece is coupled to the column faces, and wherein the cross-piece and elongated member are put into tension to form a column.

FIG. 20 shows a top view of a column including a cross-piece, such as shown in FIGS. 18 and 19.

FIG. 21 shows a perspective view of an upper portion of a column face for forming a column and panel fence, such as shown in FIG. 1, the column face including a coupling feature comprised of a discrete surface feature in the upper surface of the column face.

FIG. 22 shows a perspective view of a cross-piece comprised of a bracket having enlarged end portions configured to couple with the coupling feature of the column face shown in FIG. 21.

FIG. 23 shows a top view of a column including the cross-piece of FIG. 22 coupled with column faces, such as shown in FIG. 21, and having a bolt coupling the cross-piece to an elongated member.

FIG. 24 shows a cross-sectional side view of the column of FIG. 23, wherein the cross-piece is coupled to the column faces, and wherein the cross-piece and elongated member are put into tension to form the column.

FIG. 25 shows a cross-sectional side view of a precursor assembly for forming a column and panel fence, such as shown in FIG. 1, the precursor assembly including an uneven footing coupled to an elongated member, discrete column faces positioned at different elevations on the uneven footing, and a cross-piece, such as is shown in FIGS. 7-9, positioned over the column faces and coupled to the elongated member.

FIG. 26 shows the precursor assembly of FIG. 25, wherein the cross-piece is coupled to the column faces, and wherein the cross-piece and elongated member are put into tension to form a column.

### DETAILED DESCRIPTION

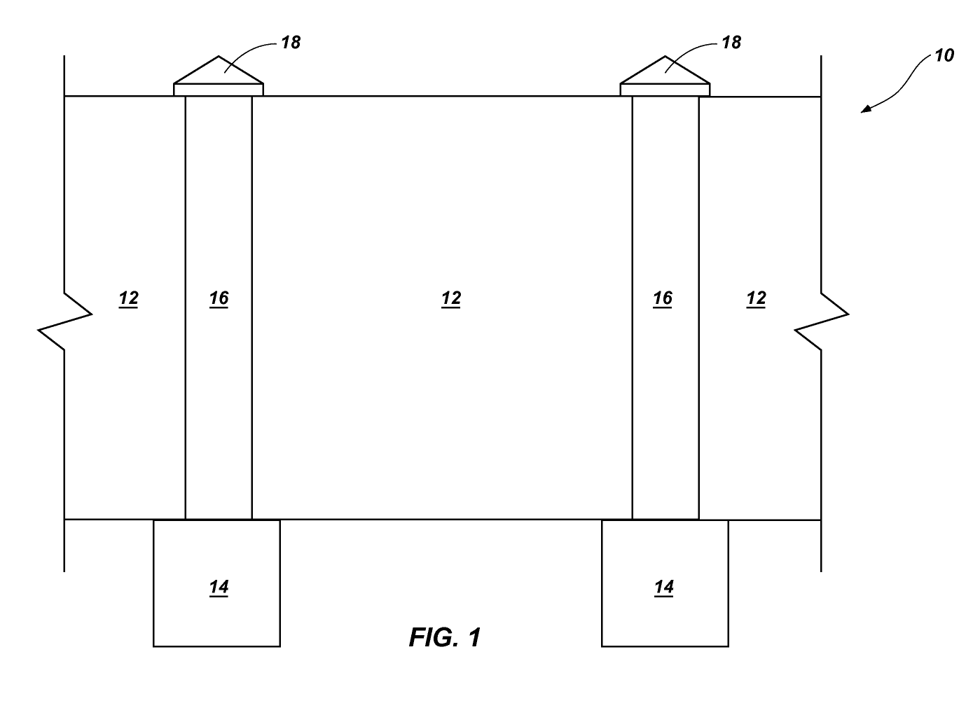

In some embodiments, as shown in FIG. 1, a column and panel fence 10 may include a plurality of panels 12 positioned end to end. The panels 12 may be supported at their ends by footings 14 and columns 16 coupled to the footings 14. Optionally, each of the columns 16 may include a cap 18 positioned thereon.

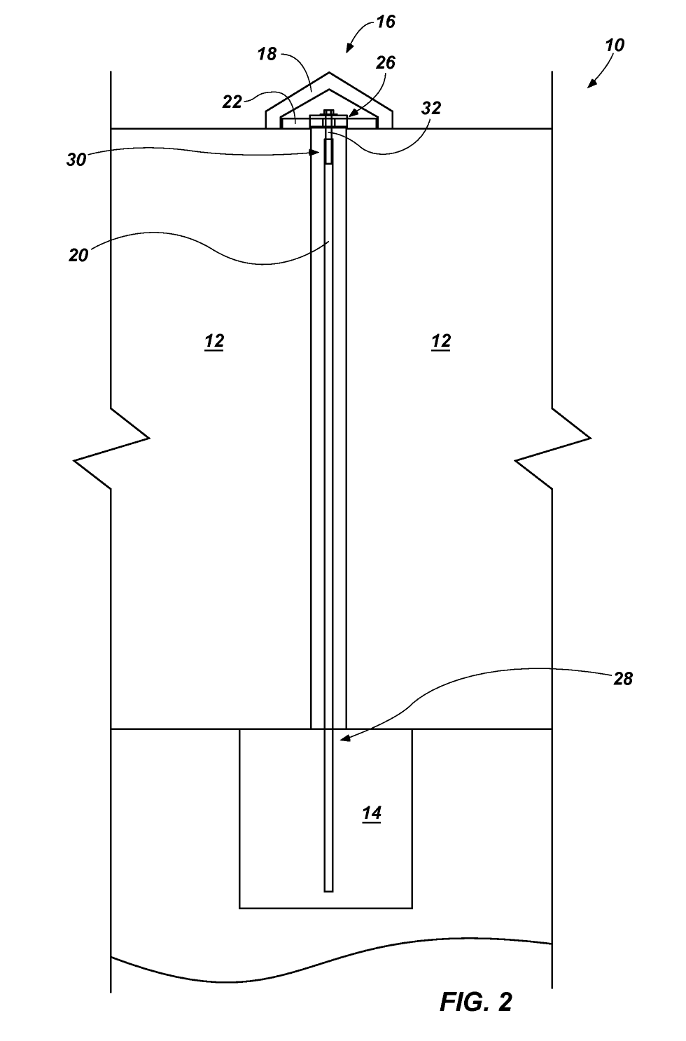

As shown in a cross-sectional view in FIG. 2, each column 16 of the fence 10 may be an assembly of several components. For example, each column 16 may include an elongated member 20 extending from a footing 14, a first column face 22, an opposing second column face 24 (FIG. 6) and a cross-piece 26. The elongated member 20 may include a first end 28 secured to the footing 14 and a second end 30 coupled to the cross-piece 26. The first and second column faces 22, 24 may be positioned on either side of the end portions of the panels 12, the first and second column faces 22, 24 forming a channel therebetween sized and configured to receive the end portion of the panels 12. The cross-piece 26 may have a first end coupled to the first column face 22 and a second end coupled to the opposing second column face 24, and an intermediate portion of the cross-piece 26 may be coupled to the second end 30 of the elongated member 20 by a coupler, such as by a bolt 32. The cross-piece 26 may hold the first and second column faces 22, 24 against the panels 12 and may apply a longitudinally oriented compressive force on the first and second column faces 22, 24. Additionally, the cross-piece 26 and the elongated member 20 may be placed in tension by the footing 14, the first column face 22 and the second column face 24. The cap 18 may be positioned over the top of the column 16, which may provide a decorative finish and may provide shelter and protection to the interior components of the column 16, such as the cross-piece 26 and the elongated member 20. For example, the cap 18 may be formed of molded monolithic concrete and include a cavity therein for positioning over the column 16.

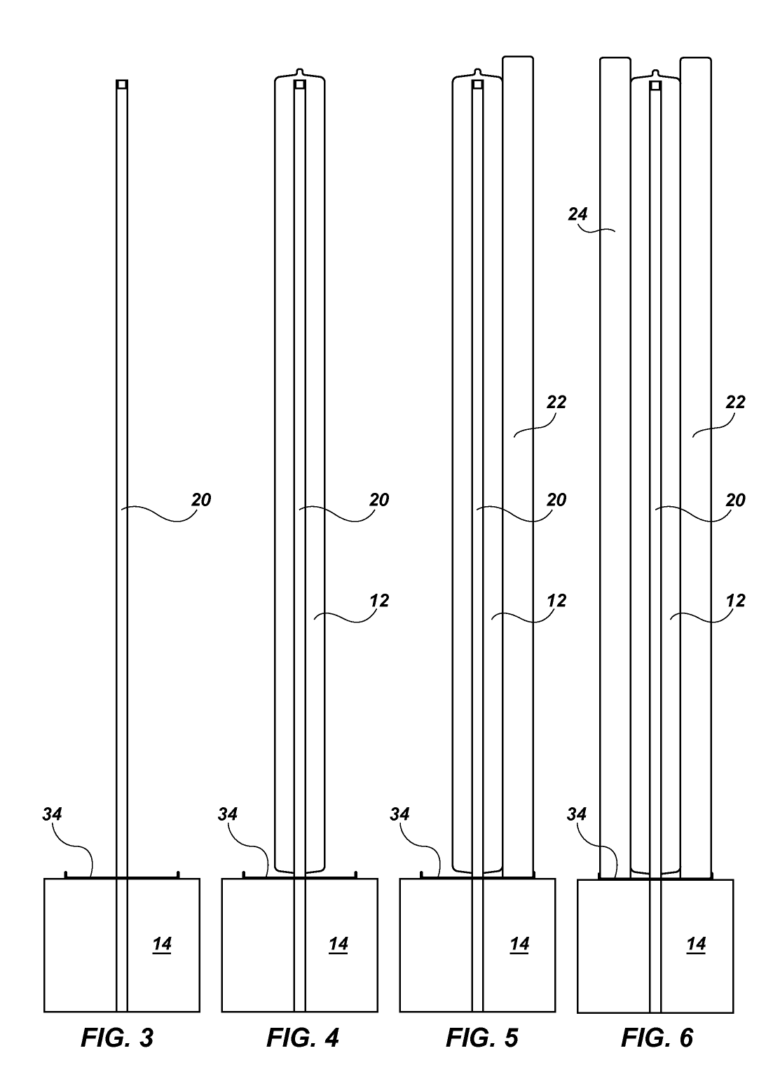

In some embodiments, a column and panel fence 10 may be assembled by first positioning footings 14, securing elongated members 20 to the footings 14 and positioning an optional retaining bracket 34 about each elongated member 20, as shown in FIG. 3. Next, end portions of the panels 12 may be positioned over the footings 14 and generally aligned with respective elongated members, as shown in FIG. 4. The panels 12 may be held in position by temporary braces (not shown) until the columns 16 are assembled.

After the panels 12 are positioned, a first column face 22 may be positioned adjacent the end portions of the panels 12, as shown in FIG. 5, and a second column face 24 may be positioned adjacent the ends portions of the panels 12 opposite the first column face 22, as shown in FIG. 6. Optionally, if the first and second column faces 22, 24 are joined together by a central portion (i.e., the first and second column faces are a single piece) (not shown) the first and second column faces 22, 24 may be positioned simultaneously, such as by lowering the first and second column faces 22, 24 over the elongated member 20 and footing 14.

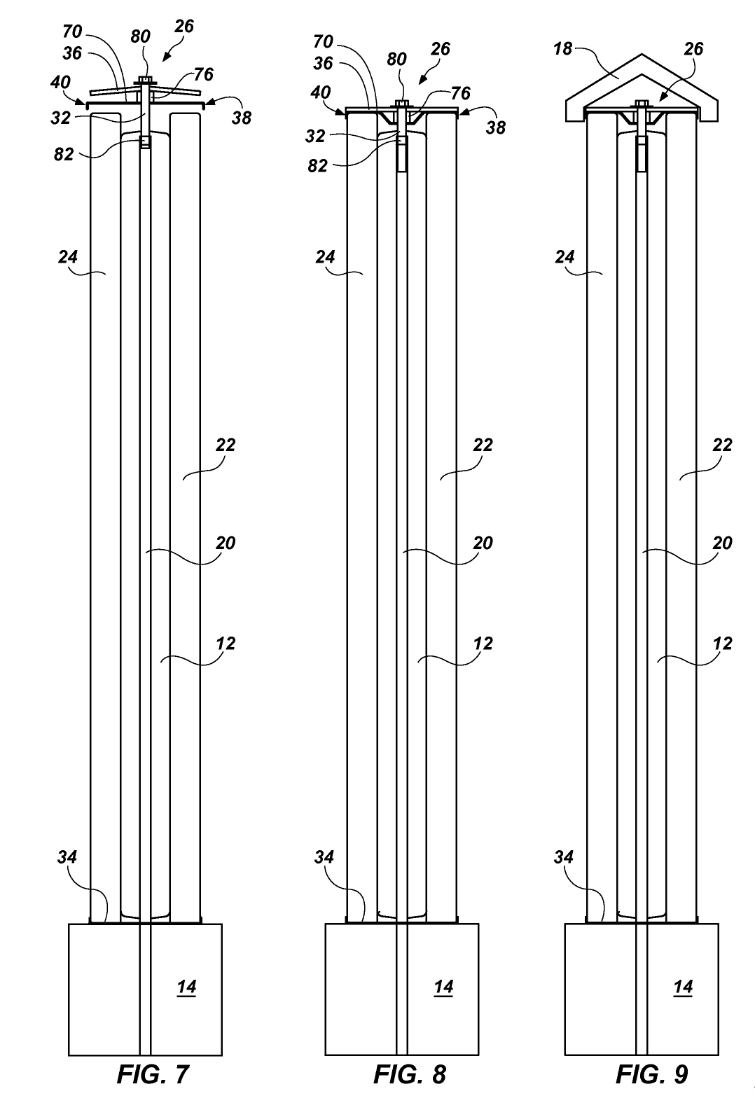

The lower ends of the first and second column faces 22, 24 may be held against the panels 12 by a retaining bracket 34 or by another structure as will be discussed further herein. If a retaining bracket 34 is used, the retaining bracket 34 may comprise a metal bracket that may be deformed or may be rotated, such as by a hammer, to hold the lower ends of the column faces 22, 24 firmly against the panels 12. A cross-piece 26 may then be positioned at the upper end of the column faces 22, 24 and, optionally, a retainer 36 may be positioned over the cross-piece 26, as shown in FIG. 7. A first end 38 of the cross-piece 26 may be coupled to the first column face 22, a second end 40 of the cross-piece 26 may be coupled to the second column face 24, and an intermediate portion of the cross-piece 26 may be coupled to the elongated member 20, as shown in FIG. 8. A portion of the cross-piece 26 may then be deformed, such as by rotating the bolt 32, and the cross-piece 26 and the elongated member 20 may be held in tension by the footing 14, the first column face 22 and the second column face 24. The tensioned cross-piece 26 may then hold the column faces 22, 24 firmly against the panels 12 and apply a longitudinally oriented compressive force to the column faces 22, 24. Upon putting the cross-piece 26 and the elongated member 20 into tension, the column 16 may support the panels 12 and any temporary braces (not shown) may then be removed. Finally, the cap 18 may be positioned over the upper end of the column 16, as shown in FIG. 9.

Column and panel fences 10, such as shown in FIG. 1, may be assembled using many different embodiments of footings. In some embodiments, such as shown in FIGS. 1-9, the footings 14 may be formed by flowing uncured concrete into a hole in the ground and curing the concrete within the hole. With such concrete footings 14, the elongated member 20 may be fixed to the footing 14 by positioning the elongated member 20 within the hole and curing the concrete around the elongated member. Alternatively, the concrete may be cured to form the footing 14, then a hole may be drilled into the footing 14 and the elongated member 20 may be fixed in the hole, such as with an adhesive (i.e., epoxy).

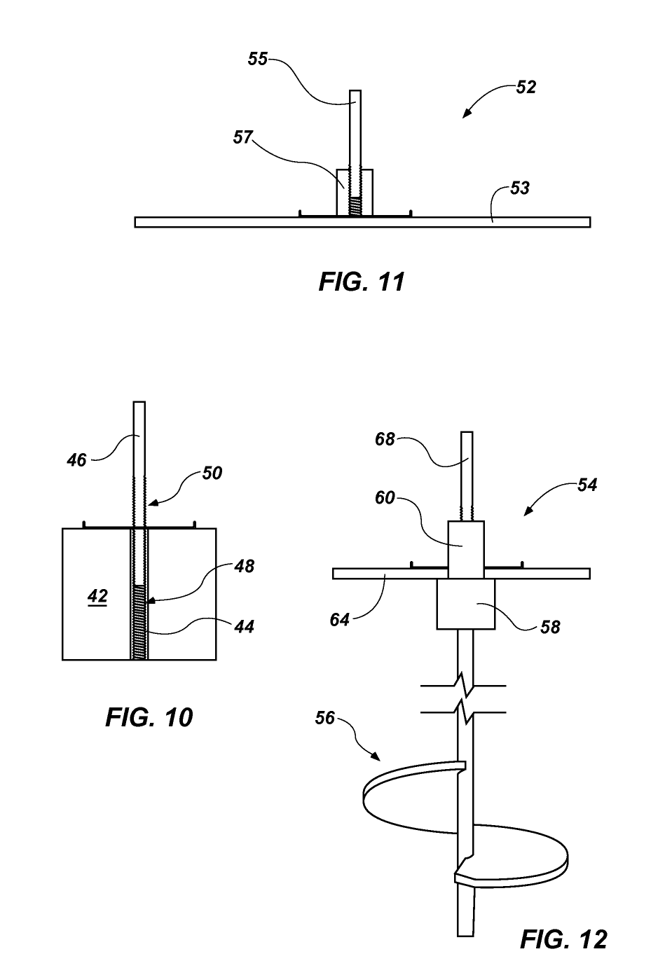

In additional embodiments, such as shown in FIG. 10, a footing 42 may be formed, such as by flowing uncured concrete into a hole in the ground and curing the concrete within the hole and may include an insert 44 positioned therein. In such embodiments, a reusable elongated member 46 may be fixed to the footing via the insert 44. As used herein, the term “reusable” means a component configured to be disassembled from an installed configuration without significant damage thereto and without significant damage to other components of the assembly and reinstalled without significant modification thereto and without significant modification to other parts of the assembly. In one embodiment, an insert 44 may be fixed to the footing 42, such as by curing the concrete around the insert 44 or by an adhesive (i.e. epoxy). The elongated member 46 may then be coupled to the insert 44 fixed to the concrete footing 42. For example, the insert 44 may be tubular and include a threaded interior portion 48 and the elongated member 46 may be a metal rod or tube having mating threads 50 formed on an exterior portion thereof, as shown in FIG. 10, which may enable the elongated member 46 to be uncoupled from and recoupled to a concrete footing 42 having an insert 44 positioned therein.

In further embodiments, such as shown in FIGS. 11 and 12, a footing 52, 54 may be a reusable footing 52, 54 that may be readily removed from an installed state and reinstalled at the same location or installed at another location. For example, as shown in FIG. 11, a footing 52 may be configured to extend laterally over a surface (not shown), such as for example the surface of the earth. In such an embodiment, the footing 52 may include a metal plate 53, or other laterally extending structure (i.e., extending horizontally over a surface, generally perpendicular to the fence), that may be positioned on the surface and coupled to an elongated member 55, such as by a threaded coupler 57 attached to the plate 53.

In another example, as shown in FIG. 12, a footing 54 may include a reusable subterranean structure that may be readily removed from an installed state and reinstalled at the same location or installed at another location, such as a helical pier 56. For example, the helical pier 56 may include a collar 58 and a coupler 60 at an upper end thereof. The coupler 60 may be attached to equipment (not shown) that may rotate and drive the helical pier 56 into the ground (not shown); such that the upper end of the collar 58 may be near the surface of the ground. The coupler 60 may then be detached from the installation equipment (not shown) and a plate 64 having an aperture 66 therein may be positioned over the collar 58 with the coupler 60 extending through the aperture 66. An elongated member 68 may then be coupled with the coupler 60. The ends of panels 12 and first and second column faces 22, 24 may then be positioned over the plate 64 and a column 16 may be formed, such as discussed with reference to FIGS. 7 and 8.

Additionally, columns 16 for column and panel fences 10, such as shown in FIG. 1, may be formed using various embodiments of cross-pieces. In some embodiments, such as shown in FIG. 8, a cross-piece 26 may include a bracket 70 formed from a metal sheet. The bracket 70 may include bent end portions 28, 30, for coupling with the upper ends of the column faces 22, 24. The bracket may further include an aperture intermediate the bent end portions 28, 30, for coupling the bracket 70 to the elongated member 20 with a coupler, such as a bolt 32.

As shown in FIG. 7, initially, the portion of the bracket 70 intermediate the bent end portions 28, 30 may be substantially flat. If a retainer 36 is used, the retainer 36 may also be substantially flat, or may be pre-stressed (i.e., bent) as shown in FIG. 7, and may similarly include an aperture therethrough. The retainer 36 may be formed from a relatively resilient metal, such as a spring steel, and may have a greater thickness than the bracket 70. The assembly may also include a spacer 76, which may be generally annular in shape, having an aperture therethrough.

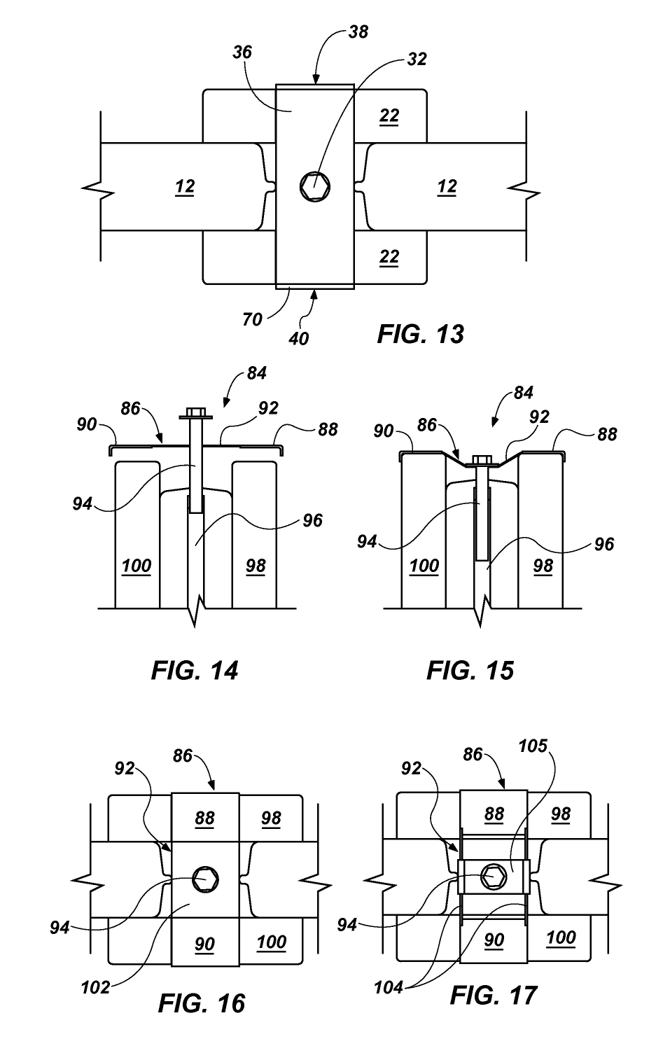

The bolt 32 may be positioned through the aperture of the retainer 36, the aperture of the spacer 76 and the aperture of the bracket 70. The spacer 76 may be positioned between the retainer 36 and the bracket 70, and the retainer 36 may be proximate a head 80 of the bolt 32. The bolt 32 may then be coupled to a mating threaded portion, such as a nut 82, at the second end 30 of the elongated member 20. As the bolt 32 is rotated and threaded into the nut 82 of the elongated member 20, the head 80 of the bolt 32 may move downward, closer to the elongated member 20. As the bolt 32 is further rotated, the spacer 76 may push downward against a central portion of the bracket 70 while the first and second column faces 22, 24 may apply an upward force against the end portions 38, 40 of the bracket 70, and the bracket 70 may deform. As the bracket 70 deforms, the bent ends 28, 30 may be pulled toward the central region and may apply a force to the upper end of each of the column faces 22, 24 pulling the upper end of the column faces 22, 24 toward the panels 12. As the bracket 70 deforms the retainer 36 may apply a downward force on the bracket 70 near the ends 28, 30 thereof and may prevent the ends 28, 30 of the bracket 70 from lifting upward and away from the column faces 22, 24 and may prevent the ends 28, 30 of the bracket 70 from becoming uncoupled with the upper ends of the column faces 22, 24. If the retainer 36 is bent, as shown in FIG. 7, the retainer 36 may be deformed to a generally flat configuration as the bolt 32 is tightened, as shown in FIG. 8. Upon tightening the bolt 32, the bracket 70, bolt 32, and elongated member 20 may be put into tension and the column faces 22, 24 may be longitudinally compressed, held against the panels 12 and secured in place. A top view of the installed bracket 70 and retainer 36 is shown in FIG. 13, showing the head 80 of the bolt 32 over the retainer 36, the retainer 36 positioned over the bracket 70, and the ends 28, 30 of the bracket extending over and coupling with the column faces 22, 24 and holding the column faces 22, 24 in position against the panels 12.

In additional embodiments, the cross-piece may not include a retainer and a spacer. As shown in FIG. 14, a cross-piece 84 may include a bracket assembly 86 having a first relatively rigid end portion 88, a second relatively rigid end portion 90 and a relatively flexible intermediate region 92. A coupling member, such as a bolt 94, may be coupled to the intermediate portion 92 and the first and second end portions 88, 90 may be positioned over first and second column faces 22, 24, respectively. The bolt 94 may be threadably coupled to the elongated member 96 and rotated. As the bolt 94 is rotated, the first end portion 88 of the bracket assembly 86 may become coupled with the first column face 98 and the second end portion 90 may become coupled to the second column face 100, as shown in FIG. 15. The intermediate portion 92 of the bracket assembly 86 may be sufficiently flexible to allow the deformation of the bracket assembly 86 as the bracket assembly 86 is put into tension by the bolt 94 and the elongated member 96 without causing significant deformation of the relatively rigid end portions 88, 90. As the relatively rigid end portions 88, 90 may not be significantly deformed, the relatively rigid end portions 88, 90 may remain coupled to the respective column faces 98, 100 as the bracket deforms under tension without requiring a retainer to be positioned over the bracket assembly 86.

In some embodiments, the relatively flexible intermediate portion 92 may include a relatively flexible metal sheet portion 102, such as shown in a top view in FIG. 16. In additional embodiments, the relatively flexible intermediate portion 92 may include one or more cables 104, such as shown in another top view in FIG. 17. In such embodiments, the bracket assembly 86 may, optionally, include a central bracket portion 105 that may facilitate coupling of the bolt 94 to the relatively flexible intermediate portion 92, such as to the cables 104.

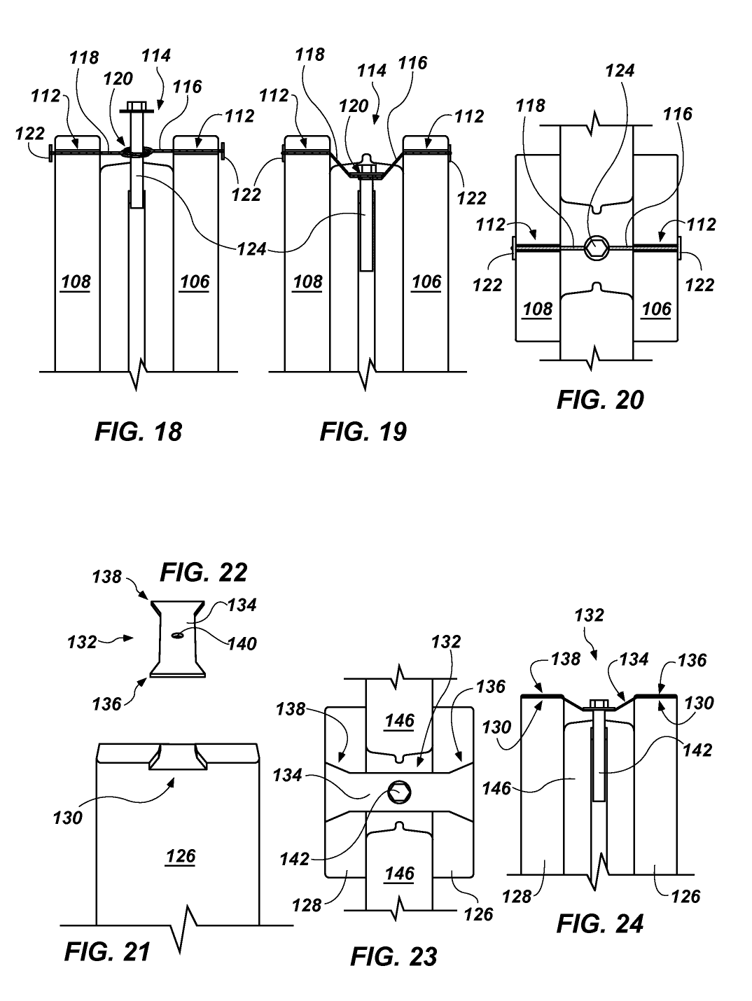

In additional embodiments, the upper ends of a first column face 106 and a second column face 108 may include discrete coupling features 110. As shown in FIG. 18, the upper end of each of the first and second column faces may include a channel, such as an aperture 112 formed therethrough. A cross-piece 114 may include a first cable assembly 116 and a second cable assembly 118 that may be positioned through the apertures 112 of the first and second column faces 106, 108, respectively. Each cable assembly 116, 118 may include a looped end 120 and an enlarged end portion 122. For example, each cable assembly 116, 118 may include a looped end 120 formed from a looped cable that may be relatively flexible and may be sized and configured to be inserted into a discrete coupling feature 110 of the column faces 106, 108, such as through an aperture 112.

Each enlarged end portion 122 may have a dimension larger than a diameter of each aperture 112, which may prevent the passage of the enlarged end portion 122 through the aperture 112. For example, each enlarged end portion 122 may be a metal structure that is swaged, welded, or otherwise coupled to a cables assembly 116, 118.

After inserting the looped ends 120 of the first and second cable assemblies 116, 118 through the apertures 112 of the first and second column faces 106, 108, respectively, a coupler, such as a bolt 124, may be positioned through the looped ends 120 of the and coupled to the elongated member. As shown in FIG. 19, and in a top view in FIG. 20, the bolt 124 may be rotated until the first and second cable assemblies 116, 118 are put into tension.

In additional embodiments, such as shown in FIG. 21, a first column face 126 and a second column face 128 (FIG. 23) may include a surface feature 130 in the upper region configured to couple with a cross-piece 132 (FIG. 22). As shown in FIG. 22, the cross-piece 132 may include a bracket 134 that may include coupling features at opposing ends thereof, such as a first enlarged end portion 136 and a second enlarged end portion 138. Additionally, the bracket 134 may include an aperture 140 positioned at an intermediate region. The bracket 134 may be formed of a metal sheet, such as a steel sheet, and the bracket 134 may be substantially flat prior to installation.

As shown in a top view in FIG. 23, the first enlarged end portion 136 of the bracket 134 may be positioned within the surface feature 130 of the first column face 126 and the second enlarged end portion 138 of the bracket 134 may be positioned within the surface feature 130 of the second column face 128. A coupler, such as a bolt 142, may be inserted through the aperture 140 and coupled to an elongated member 144. The bolt 142 may be tightened and deform the bracket 134, such as shown in a side view in FIG. 24. As the bracket 134 is deformed the enlarged end portions 136, 138 may be pulled toward the central region of the bracket 134 and may become wedged within the surface features 130 of the column faces 126, 128 coupling the bracket 134 and the column faces 126, 128 together. Additionally, as the bracket 134 is deformed, the bracket 134 and the elongated member 144 may be put into tension and the bracket 134 may apply a longitudinal compressive force to the column faces 126, 128 and may secure the column faces 126, 128 against panels 146 positioned therebetween.

Utilizing a column 148 that comprises a first column face 150 and second column face 152 that may each be positioned independent of the other coupled by a cross-piece 154, similar to the cross piece 26 as described with reference to FIGS. 7-9, and 13, may allow a column 148 to be reliably installed on an uneven footing 156, such as shown in FIG. 24. The first column face 150 may be positioned on the uneven footing 156 adjacent end portions of panels 158 at a first elevation. The second column face 152 may be positioned on the uneven footing 156 adjacent the opposing side of the end portions of the panels 158 at a second elevation, different than the first elevation. In one embodiment, the first column face 150 may be positioned at an elevation that is lower than an elevation of the second column face 152. As a result of the difference in elevations of the column faces 150, 152, indicated by dimension D1, the upper ends of the column faces 150, 152 may be out of alignment, as indicated by dimension D2 (which may be substantially equal to D1).

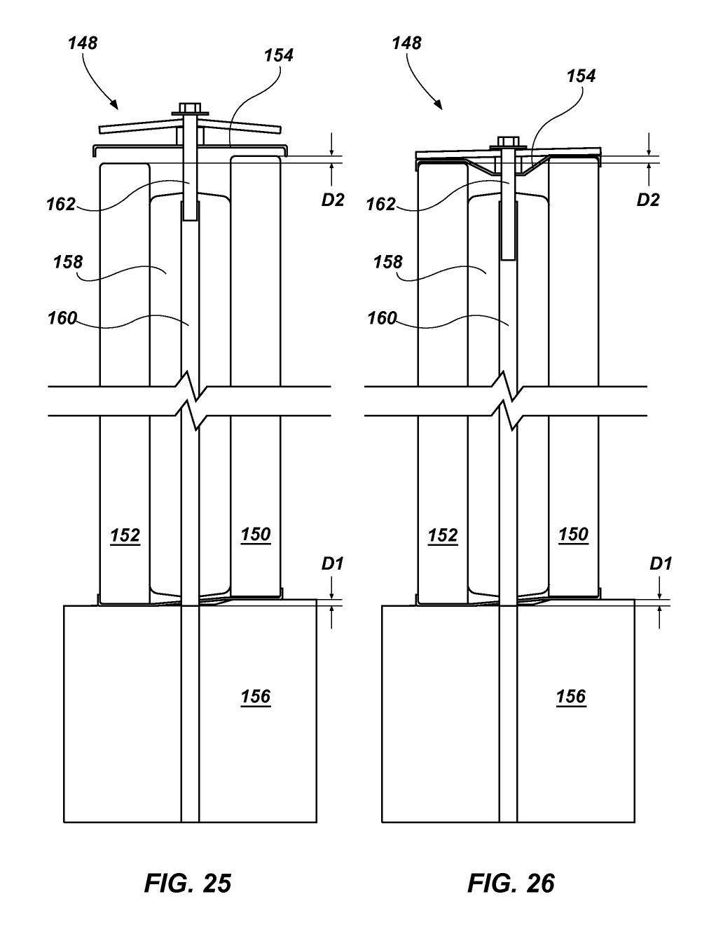

The cross-piece 154 may then be positioned over the upper end portions of the column faces 150, 152 may be coupled to an elongated member 160 extending from the uneven footing 156. As shown in FIG. 25, when the coupler, such as a bolt 162, is secured to the elongated member 160 and the cross-piece 154 and elongated member 160 are put into tension, the cross-piece 154 may deform to effectively couple with the upper ends of the column faces 150, 152 even though the upper ends of the column faces 150, 152 are not aligned.

In additional embodiments, the column 148 may be installed on a footing having an upper surface defining a plane that is non-perpendicular to the longitudinal orientation of the column 148. For example, an upper surface of a footing may not be level (i.e., not perpendicular to a direction of earth's gravitational force) and the column 148 may be installed with a longitudinal orientation that is plumb (i.e., parallel to a direction of earth's gravitational force). In another example, an upper surface of a footing may be level and the column 148 may be installed with a longitudinal orientation that is not plumb (i.e., the column may be canted). For such embodiments, bottom surfaces of the first column face 150 and the second column face 152 may each define a plane that does not lie in the same plane as, and is not parallel to, a plane defined by the upper surface of the footing.

By utilizing column assemblies as described herein, a column and panel fence may be configured so that the fence 10 may be reusable. In one embodiment, a portion of a column and panel fence may be disassembled to provide a temporary opening, such as to facilitate access of relatively large equipment, and then the portion may be reassembled. In such an embodiment, a footing 42, 52, 54 and reusable elongated member 46, 55, 68 such as shown and described with reference to FIGS. 10-12 may be utilized, and a cross-piece 26, 84, 114, 132, 154 may also be utilized. In view of this design approach, a column and panel fence may be installed by methods as described herein. When desired, a portion of the column and panel fence may then be removed by first removing the cap from the column, if a cap is included, and optionally providing temporary bracing (not shown) to portions of the fence, such as the panels. Then, the cross-piece may be decoupled from the elongated member by removing the coupler. After removing the cross-piece, the column faces may be removed and the panels may be removed. Upon removing the column faces, the elongated member may be accessible and removed, such as by decoupling the elongated member from the footing (i.e., rotating and uncoupling a threaded connection). After the temporary opening is no longer needed, the removed fence portion may then be reinstalled using the same components and methods used for the original installation.

In another embodiment, a column and panel fence may be assembled at a location as a reusable fence (i.e., a temporary fence), such as at a construction site, a festival, an emergency (disaster) response site, or other temporary use site. For a temporary use, the fence may be installed at a location for use, and upon completion of use, the fence may be disassembled and then installed at another site. In such embodiments, a removable and reusable footing 52, 54 and reusable extending member 55, 68, such as shown and described in FIGS. 11 and 12, may be utilized and a cross-piece 26, 84, 114, 132, 154 may also be utilized. In view of this, a column and panel fence may be installed at a site by methods described herein. When the temporary use is complete, the column and panel fence may then be removed by first removing the cap from the column, if a cap is included, and optionally providing temporary bracing to portions of the fence, such as the panels. Then, the cross-piece may be decoupled from the elongated member by removing the coupler, such as by unscrewing a bolt. After removing the cross-piece, the column faces may be removed and the panels may be removed. Upon removing the column faces, the elongated member may be accessible and removed, such as by decoupling the elongated member from the footing (i.e., rotating and uncoupling a threaded connection). Finally, the footing may be removed. If a footing is comprised of a transversely extending member positioned on the ground surface, such as shown in FIG. 11, the footing may be simply lifted from the ground surface. If a footing includes a removable subterranean structure, such as helical pier as shown in FIG. 12, the subterranean structure may be removed from the ground, such as by coupling to equipment (not shown) and rotating and lifting from the ground. The temporary fence may then be installed at another location using the same components and methods used for the previous installation.

In some embodiments, with reference to FIG. 1, the column and panel fence 10 may be comprised of preformed concrete components. The panels 12 may be cast from concrete in a single monolithic piece or as a plurality of pieces assembled together to form the panel. For example, each panel 12 may be formed of two monolithic sheets, each sheet cast in a mold, and a face of each sheet may have a finished surface imparted by the mold. The sheets may be assembled back to back, such the faces of the sheets, having the finished surface imparted by the mold, may form the outer surface of the panel 12. Optionally, each panel 12 may also include reinforcing structures, such as one or more of reinforcing bar (rebar), reinforcing fiber, and reinforcing wire therein and may include materials, such as adhesives and filler material, therebetween.

Additionally, with reference to FIG. 9, the column faces 22, 24 may be comprised of concrete and may be preformed, such as in a mold. For example, each of the column faces 22, 24 may be formed of cast concrete, which may be reinforced, such as with one or more of reinforcing bar (rebar), reinforcing fiber and reinforcing wire. In some embodiments, each of the column faces 22, 24 may not include any exterior or exposed portions that are not formed of concrete.

Although certain concrete panels and concrete column faces have been described, panels and column faces formed of other materials and by other methods may also be used, as will be understood by a person of ordinary skill in the art.

Although a retaining bracket 34 is described and used in some embodiments described herein, additional embodiments may not utilize a retaining bracket 34 and the lower ends of the column faces may be otherwise retained. In some embodiments, the footing may include a structure (not shown) to secure the lower ends of the column faces, such as one or more of protrusions, recesses, and other retaining features. In additional embodiments, the lower ends of the column faces may be retained by friction between the column faces and the footing. It will be understood by a person of ordinary skill in the art that additional structures and methods may also be used to secure the lower ends of the column faces.

Additionally, although a bolt is provided as a non-limiting example of a coupler for joining the cross-piece to the elongated member for several embodiments, other couplers may also be suitable, as will be understood by a person of ordinary skill in the art.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention includes all modifications, equivalents, and alternatives falling within the scope of the invention as defined by the following appended claims.

What is claimed is:

1. A column for a column and panel fence, comprising:
an elongated member having a first end secured to a footing and a second end;
a first column face and an opposing second column face forming at least one channel therebetween sized and configured to receive an end portion of at least one fence panel;
a cross-piece having a first end coupled to the first column face, a second end coupled to the second column face and an intermediate portion coupled to the second end of the elongated member, the cross-piece and the elongated member being placed in tension by the footing, the first column face and the second column face at least when an end portion of at least one fence panel is positioned in the at least one channel.

2. The column of claim 1, wherein the first column face and the second column face are discrete structures.

3. The column of claim 2, wherein the first column face and the second column face comprise concrete.

4. The column of claim 2, wherein the first column face is secured at an elevation different than an elevation of the second column face.

5. The column of claim 1, wherein the cross-piece is coupled to the second end of the elongated member by a threaded connection.

6. The column of claim 1, further comprising a retaining bracket for securing a lower end of the first column face and the second column face.

7. The column of claim 1, wherein the footing comprises a reusable footing.

8. The column of claim 7, wherein the footing comprises a metal plate extending laterally over a ground surface.

9. The column of claim 7, wherein the footing comprises a reusable subterranean structure.

10. The column of claim 9, wherein the reusable subterranean structure comprises a helical pier.

11. The column of claim 1, wherein the cross-piece comprises a bracket.

12. The column of claim 11, wherein the bracket comprises bent end portions for coupling to the first column face and the second column face.

13. The column of claim 12, wherein the cross-piece further comprises a retainer positioned over the bracket.

14. The column of claim 13, wherein the cross-piece further comprises a spacer positioned between the bracket and the retainer.

15. The column of claim 11, wherein the cross-piece further comprises at least one cable.

16. The column of claim 1, wherein the first column face and the second column face each comprise a discrete coupling feature.

17. The column of claim 1, wherein the elongated member comprises a metal tube.

18. The column of claim 1, wherein the cross-piece and the elongated member are coupled by a threaded connection.

19. The column of claim 1, wherein the footing and the elongated member are coupled by a threaded connection.

20. A column and panel fence, comprising:
a plurality of panels positioned substantially end-to-end; and
a plurality of columns supporting the plurality of panels, each column of the plurality of columns comprising:
an elongated member having a first end secured to a footing and a second end positioned between ends of adjacent panels of the plurality;
a first column face and an opposing second column face forming at least one channel therebetween receiving an end portion of at least one panel of the plurality of panels;
a cross-piece having a first end coupled to the first column face, a second end coupled to the second column face and an intermediate portion coupled to the second end of the elongated member, the cross-piece and the elongated member being placed in tension by the footing, the first column face and the second column face.

21. The column and panel fence of claim 20, wherein:
the plurality of panels are comprised of concrete; and
the first column face and the second column face of each of the columns of the plurality of columns are comprised of concrete.

22. The column and panel fence of claim 20, wherein:
at least one elongated member of the plurality of columns is a reusable elongated member releasably coupled with the footing.

23. The column and panel fence of claim 22, wherein:
the at least one elongated member is coupled to the footing by a threaded connection at a first end thereof; and
the at least one elongated member is coupled to the cross-piece by a threaded connection at a second end thereof.

24. A reusable concrete fence comprising:
a plurality of concrete panels positioned substantially end-to-end; and
a plurality of columns supporting the plurality of panels, each column of the plurality of columns comprising:
a reusable elongated member having a first end releasably coupled to a footing and a second end;
a first concrete column face and an opposing second concrete column face forming at least one channel therebetween receiving an end portion of at least one concrete panel of the plurality of concrete panels;
a reusable cross-piece having a first end coupled to the first column face, a second end coupled to the second column face and an intermediate portion coupled to the second end of the elongated member by a threaded connection, the cross-piece and the elongated member being placed in tension by the footing, the first column face and the second column face.

25. A method of assembling a column and panel fence, comprising:
coupling an extending member to a footing;
positioning an end portion of at least one panel proximate the extending member;
positioning a first column face adjacent the end portion of the at least one panel;
positioning a second column face adjacent the end portion of the at least one panel, opposing the first column face;
coupling a cross-piece to the extending member, the first column face and the second column face;
placing the cross-piece and extending member into tension with the footing, first column face and second column face; and
longitudinally compressing the first column face and the second column face with the cross-piece.

26. The method of claim 25, wherein coupling a cross-piece to the extending member further comprises coupling threads formed in the extending member with mating threads formed in a coupler.

27. The method of claim 25, wherein coupling an extending member to a footing further comprises coupling threads formed in the extending member with mating threads of the footing.

28. A fence kit comprising:
an elongated member having a first end configured for securing to a footing and a second end;
a first column face and an opposing second column face configured for forming at least one channel therebetween sized and configured to receive an end portion of at least one fence panel;
a cross-piece having a first end sized and configured to couple to the first column face, a second end sized and configured to couple to the second column face and an intermediate portion configured to couple to the second end of the elongated member, the cross-piece and the elongated member sized and configured to be assembled and placed in tension by the footing, the first column face and the second column face at least when an end portion of at least one fence panel is positioned in the at least one channel.
